(19) United States
(12) Patent Application Publication
(10) Pub. No.: US 2007/0115435 A1
(43) Pub. Date: May 24, 2007

(54) Projector and method of projecting an image having multiple image sizes

(75) Inventor: Wilhelmus Joseph Rosendaal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLOJKE PHILIPS ELECTRONICS N.V., Eindhoven (NL)

(21) Appl. No.: 10/582,380

(22) PCT Filed: Dec. 13, 2004
(86) PCT No.: PCT/IB04/52782

§ 371 Date: Jun. 9, 2006

Related U.S. Application Data
(60) Provisional application No. 60/529,585, filed on Dec. 15, 2003.

(51) Int. Cl. G03B 21/26

(52) U.S. Cl. 353/30

(57) ABSTRACT

A front projection display system (100) selectively operates in either a “normal” television-replacement mode, which projects a smaller-sized image, or in a large-format “cinema” projection mode with a larger-sized image. A display size selection can be made automatically according to factors such as ambient light level, and/or manually under user control. In response to the display size selection, a controller (140) retrieves appropriate data from memory (145), and controls a projection lens system (130) to display an image on an image projection surface (150) in either a first, larger-sized, format or in a second, smaller-sized format.

This invention pertains to the image projectors, and in particular, to front projection display systems wherein a size of a displayed image may be varied.

Front projection display systems are gaining increasing popularity as their prices decrease, and both image quality and illumination intensity improve. Under proper lighting conditions, front projection display systems are capable of displaying excellent-quality video images at large sizes (e.g., 120″ diagonal) that are not generally possible or practical with other types of conventional display systems (e.g., a cathode ray tubes, rear projection displays, plasma displays, liquid crystal displays, etc.). Front projection display systems are especially popular for displaying video content such as movies and sports in a large format. In the past, such front projection display systems have mainly been used in home theaters, basements, living rooms, and other larger viewing areas where it was desired to provide a “home cinema” experience with a very large displayed image.

Meanwhile, as the image quality and illumination intensity improve, and as prices decrease, it is becoming possible for many people to consider a front projection display system as a replacement unit for a “normal” television display, such as a cathode ray tube display, a rear projection display, or a plasma display device, in the living room, family room, etc.

However, for a variety of reasons, viewers do not always want to view a video program displayed in a large format (e.g., 120″ diagonal). For example, violent images in news programs, frightening animated cartoon characters, etc. may be too upsetting, (especially to small children) if displayed at such a large size. Also, at the same time that one or more people may be watching a news program or other television program displayed by a front projection display system, other people in the same room may be engaged in other activities such as conversation, game playing, reading, etc. In that case, a gigantic image (e.g., 120″ diagonal) may be distracting or disturbing to these other activities.

In these cases, users would prefer to view the video content in a more traditional, “normal” size (e.g., 28″ diagonal).

Furthermore, although the illumination intensity of front projection display systems continues to improve, a high level of background or ambient light still makes it difficult to view large format images displayed by these systems. Therefore, it is typically necessary to close curtains and/or dim the room lights in order to view larger-sized images displayed by front projection display systems.

Although people may be willing to close the curtains and/or dim (or turn off) all lights in a room in order to watch a special sporting event or a movie in a “cinema” setting, they do not want to have to always have to do this even when they just want to watch a news program, weather forecast, game show, etc. And it is not generally desired anyway to watch news and most other “normal” television programs in 120″ size format.

Furthermore, as noted above, at the same time that one or more people may be watching a regular television program displayed by a front projection display system, other people in the same room may be engaged in other activities such as conversation, game playing, reading, etc. In that case, dimming the lights or turning them off completely may make it difficult if not impossible for those other people to engage in or enjoy these activities.

As a result, there is a hindrance to the adoption of existing front projection display systems as “television replacement” displays for more generally viewing all sorts of video programs in a variety of environments.

Accordingly, it would be desirable to provide a projection display system capable of selectively operating in either a “normal” television-replacement mode (wherein it projects a smaller-sized image), or in a large-format “cinema” projection mode (wherein it projects a larger-sized image). It would also be desirable to provide such a system that can automatically select between two different display sizes for displaying an image, based upon one or more predetermined criteria, such as ambient light level, program content, video source, etc. It would be further desirable to provide a method of projecting an image that provides an automatic selection and/or a user selection between a large-sized format and a smaller, “normal television” sized format. It would further be desirable to provide a projection display system which can provide greater daylight viewing possibilities by concentrating all of the light into a smaller-sized (e.g., 28″) image. The present invention is directed to addressing one or more of the preceding concerns.

In one aspect of the invention, a projection display system comprises a light source producing light; a light modulator adapted to generate an image from the light produced by the light source; a projection lens system adapted to project the image onto an image projection surface; memory for storing first data representing a first display size for the projected image on the image projection surface and second data representing a second display size for the projected image on the image projection surface; and a controller adapted to retrieve one of the first and second data from the memory and, in response thereto, to control the projection lens system to cause the projected image to have a corresponding one of the first and second display sizes on the image projection surface.

In another aspect of the invention, a method of projecting an image with a projection display system, comprises generating an image; selectively retrieving from memory either first data, representing a first display size on an image projection surface, or second data representing a second display size on the image projection surface, and in response to the retrieved data, projecting the image onto the image projection surface at a corresponding one of the first and second display sizes.

In yet another aspect of the invention, a projection display system comprises: a light source for producing light; means for generating an image from the light produced by the light source; projection means for projecting the image onto an image projection surface; means for detecting an ambient light level present in an area where the projection display system is located; and control means adapted to control the projection means to change a size of a projected image on the image projection surface in response to the detected ambient light level.

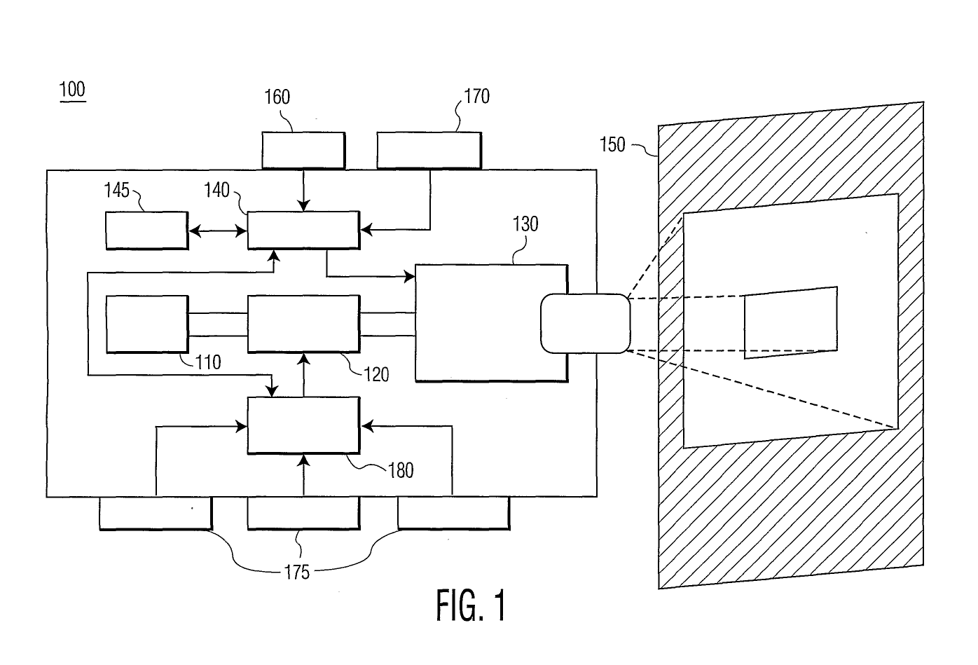

FIG. 1 shows block diagram of a first embodiment of a front projection display system according to one or more aspects of the present invention.

FIG. 1 shows a block diagram of a first embodiment of a front projection display system 100.

The front projection display system 100 comprises a light source 110, a light modulator 120, a projection lens system 130, a controller 140, memory 145, a sensor 160, a user input 170, one or more video inputs 175, and a video processor 180. A display screen or image projection surface 150 may be provided as part of the front projection display system 100, or may be separately provided, for example, as nothing more than a living room wall upon which an image is projected and displayed, as explained in more detail below.

The light source 110 may comprise an incandescent or fluorescent bulb, one of more light emitting diodes, or other convenient light emitter. Beneficially, the light source 110 includes reflectors, mirrors, and/or lenses to produce a light beam having a desired size, aspect ratio, color point, illumination distribution profile, intensity, etc., and to direct the produced light toward the light modulator 120.

The light modulator 120 may be a liquid crystal light modulator comprising one or more (e.g., three) liquid crystal devices arranged to image light in accordance with a supplied video signal and to produce a combined image comprising colored light. However, other types of light modulators 120 are also envisioned, such as a digital micromirror device (DMD).

The projection lens system 130 comprises a means for adjusting a display size of an image projected onto the projection lens system 130 in response to a control signal from the controller 140, and, beneficially, also under manual control. In one embodiment, the projection lens system 130 includes a motor-driven zoom lens that changes the display size based upon the control signal from the controller 140. In another embodiment, the projection lens system 130 includes a plurality of lenses that may be selectively moved into or out of an optical path of imaged light from the light modulator, in response to the control signal from the controller 140, to thereby change a magnification and vary a display size. Beneficially, the light modulator 120 and projection lens system 130 may include and operate with a scanning laser beam.

Beneficially, the controller 140 includes a processor executing a set of instructions to control various aspects of the front projection display system 100 as will be discussed in more detail below. Beneficially, the sensor 160 is a light sensor adapted to detect ambient light in an area where the front projection display system 100 is located. The user input 170 may include an infrared remote control sensor input, as well as one or more manual controls (e.g., switches, buttons, etc.) provided on the main body of the front projection display system 100, as will be discussed in further detail below.

The front projection display system 100 may have one video input 175, but beneficially includes a plurality of video inputs 175, which may conform to a variety of different video interface standards. For example, one video input 175 may adapted to receive video signals in a component video format. A second video input 175 may adapted to receive video signals in an RGB format. A third video input 175 may adapted to receive video signals in an “S-video” format. A fourth video input 175 may adapted to receive video signals in a composite video format. Any and all combinations are possible.

Operation of the front projection display system 100 will now be described.

Light source 110 produces light having a desired size, aspect ratio, color point, illumination distribution profile, intensity, etc., and directs the produced light toward the light modulator 120. Meanwhile, one or more video signals representing an image or sequence of images to be displayed is/are received at one or more video inputs 175.

When the front projection display system 100 has a plurality of video inputs 175, then a switch in the video processor 180 responds to a control signal from the controller 140 and selects a video signal for display (or two video signals in the case of picture-in-picture display mode). The video processor 180 may process the selected video signal(s) as desired and then provide a processed video signal to the light modulator 120.

Light modulator 120 generates an image from the light produced by the light source 110, in accordance with the video signal received from the video processor 180. Light modulator 120 provides the image to the projection lens system 130. Projection lens system 130 enlarges and formats the image for display on the image projection surface 150 (e.g. a wall of a room, a projection screen, etc.), in response to a display size selection control signal received from the controller 140, as will be explained in further detail below.

The controller 140 operates together with the projection lens system 130 to select between projecting the image onto the image projection surface 150 in either a first, larger-format, display size for providing a “cinema” viewing experience, or a second, smaller-format, display size for providing a “normal” television viewing experience. The projection lens system 130 is adapted to switch between two display sizes that vary greatly in size, in response to a control signal from the controller 140. Beneficially, the ratio of the diagonal dimension of the first display size to the diagonal dimension of the second display size is at least 3:1. In that case, the first display size may have a diagonal dimension of 120 inches, and the second display size may have a diagonal dimension of 28 inches.

Beneficially, with the smaller display size, all of the light energy may be put into the smaller area to produce a brighter image. In that case, the light intensity for images projected at the second display size (e.g., 28″) may be such that the image is easily viewable with good quality in a room with a moderate level of ambient light (e.g., daylight conditions), while images projected at the first display size (e.g., 120″) may require a darkened room with low ambient light in order to be easily viewable with good quality.

Beneficially, the first and second display sizes may be chosen or determined by a user or an installer when the front projection display system 100 is installed in a room, for example based upon the dimensions, layout, or other characteristics of the room in which the front projection display system 100 is installed. The projection lens system 130 is adapted to be adjustable to change the size of a displayed image. As explained above, such adjustment may be made, for example, by controlling a motor-driven zoom lens, by selectively moving one or more lens(es) into or out of an optical path of imaged light from the light modulator 120, or other convenient method, to thereby change a magnification of the projection lens system 130 and vary the display size of a displayed image.

Once a first desired display size is determined by the user or installer by adjusting the a magnification of the projection lens system 130, a button may be pressed on the main body of the front projection display system 100, on a remote control unit, etc., to indicate that the current configuration should be remembered or stored as the first display size. Beneficially, in response to receiving such an indication via user input 170, first data representing the chosen first display size, and the corresponding configuration of the projection lens system 130 necessary to produce the chosen first display size, is stored in memory 145. Then, the projection lens 130 is once again adjusted to change the size of a displayed image. Once a second desired display size is determined by the user or installer, a button may be pressed on either the main body of the front projection display system 100, or a remote control unit, etc., to indicate that the current configuration should be remembered or stored as the second display size. Beneficially, in response to receiving such an indication via user input 170, second data representing the chosen second display size, and the corresponding configuration of the projection lens system 130 necessary to produce the chosen second display size, is stored in memory 145. Optionally, the first and second display sizes may be changed (reprogrammed) as desired by a user command received via the user input 170.

Various embodiments of a selection means and method for selecting between the first and second display sizes will now be explained.

In one embodiment, a user manually selects whether she/he wants to view a program in a first, larger-format display size for providing a “cinema” viewing experience, or a second, smaller-format display size for providing a “normal” television viewing experience. In this case, selection between the first and second display sizes may be made “manually” by a size selection indication received from a user via user input 170. For example, user input 170 may include a switch or selection button on the main body of the front projection display system 100, on a remote control unit, etc., for switching between the first and second display sizes (e.g., a button or switch labeled “Cinema/Normal”). In response to a size selection indication received via the user input 170, controller 140 retrieves the corresponding data, representing either the first display size or the second display size, from memory 145. The controller 140 then retrieves the corresponding data from memory 145, and provides a display size selection control signal to the projection lens system 130, causing the projection lens system 130 to project an image received from the light modulator 120 with the selected display size (i.e., in either the first display size or the second display size).

In another embodiment, the display size is selected automatically by the front projection display system 100 based on one or a combination of predetermined criteria.

In one case, light sensor 160 detects a level of ambient light present in the area where the front projection display system 100 is located and provides a signal to the controller 140 indicating the ambient light level. The controller 140 may compare the ambient light level to a threshold (fixed or user-selectable) and in response thereto, select either the first (larger) display size for providing a cinema viewing experience, or the second (smaller) display size for providing a “normal” television viewing experience. The controller 140 then retrieves the corresponding data from memory 145, and provides a corresponding display size selection control signal to the projection lens system 130.

In a second case, the front projection display system 100 determines which one of the video inputs 175 has been selected for display, and in response thereto, selects either the first (larger) display size for providing a cinema viewing experience, or the second, (smaller) display size for providing a “normal” television viewing experience. For example, if it is determined that the selected video input is of a type that is or would normally be connected to a DVD player, then the front projection display system 100 automatically selects the first (larger) display size for providing a cinema viewing experience. On the other hand, if it is determined that the selected video input is of a type that is or would normally be connected to a television (e.g., terrestrial broadcast) receiver, then the front projection display system 100 automatically selects the second (smaller) display size for providing a normal television viewing experience. The controller 140 may determine which video source is selected for display, and in response thereto select either the first (larger) display size for providing a cinema viewing experience, or the second (smaller) display size for providing a “normal” television viewing experience. The controller 140 then retrieves the corresponding data from memory 145, and provides a corresponding display size selection control signal to the projection lens system 130.

In a third case, the front projection display system 100 determines a program type of an image or video signal being displayed, and in response thereto, selects either the first (larger) display size for providing a cinema viewing experience, or the second (smaller) display size for providing a “normal” television viewing experience. For example, if it is determined that the video program that is being displayed is a movie, then the front projection display system 100 selects the first (larger) display size for providing a cinema viewing experience. On the other hand, if it is determined that the video program that is being displayed is a news program, then the front projection display system 100 automatically selects the second (smaller) display size for providing a normal television viewing experience. The controller 140 may determine the video program type from a program ID received in a program guide provided to the projection display system 100 from a video source (e.g., a cable decoder or a satellite receiver or terrestrial broadcast receiver), or from information embedded in the video signal (e.g., vertical blanking interval (VBI) data such as teletext, etc.). In response to this information, the controller 140 may select either the first (larger) display size for providing a cinema viewing experience, or the second (smaller) display size for providing a “normal” television viewing experience. The controller 140 then retrieves the corresponding data from memory 145, and provides a corresponding display size control signal to the projection lens system 130.

In a fourth case, the front projection display system 100 analyzes the content of the image or video signal being displayed (e.g., color patterns; movement; etc.), and in response thereto, selects either the first (larger) display size for providing a cinema viewing experience, or the second (smaller) display size for providing a “normal” television viewing experience. For example, if it is determined that the video program that is being displayed involves a lot of motion or appropriate color patterns, it may be surmised that the program is a movie, in which case, the front projection display system 100 selects the first (larger) display size for providing a cinema viewing experience. On the other hand, if it is determined that the video program that is being displayed involves little or no motion or, has other particular color patterns, it may be surmised that the program is a “talking head” type show, in which case the front projection display system 100 automatically selects the second (smaller) display size for providing a normal television viewing experience. The controller 140 may perform the video/image content analysis, and in response thereto may retrieve the corresponding data from memory 145, and provide a corresponding display size control signal to the projection lens system 130.

Beneficially, the front projection display system 100 comprises an electronic sub-circuit (which may be separate from or part of the controller 140) to analyze the input data stream such that the type of content can be determined and the best suitable display size is automatically selected. Alternatively, the electronic sub-circuit may analyze the content of the data input to the display system to determine an advised screen size present (e.g., embedded) in the data input stream at a predetermined location.

Alternatively, the information used in the four cases described above may be combined in various ways to make an automated decision as to whether to select either the first (larger) display size for providing a cinema viewing experience, or the second (smaller) display size for providing a “normal” television viewing experience.

Beneficially, in the second embodiment (automatic display size selection), a manual override feature is included that allows a user to manually select a display size and override the automatic selection made by the front projection display system 100.

Accordingly, the front projection display system 100 is capable of selectively operating in either a “normal” television-replacement mode (wherein it projects a smaller-sized image), or in a large-format “cinema” projection mode (wherein it projects a larger-sized image). Beneficially, it can select between two different display sizes for displaying an image under user control and/or automatically based upon one or more predetermined criteria, such as ambient light level, program content, video source, etc. It also provides greater daylight viewing possibilities by concentrating all of the light into a smaller-sized (e.g., 28″) image for programs like the evening news, where a large sized format (e.g., 120″) is not desired.

While embodiments are disclosed herein, many variations are possible which remain within the concept and scope of the invention. For example, although the embodiments described above determine and store data for only two display sizes, it may be beneficial in some cases to provide for three—or some other convenient number of—display sizes. Such variations would become clear to one of ordinary skill in the art after inspection of the specification, drawings and claims herein. The invention therefore is not to be restricted except within the spirit and scope of the appended claims.

1. A projection display system (100), comprising:
a light source (110) producing light;
a light modulator (120) adapted to generate an image from the light produced by the light source (110);
a projection lens system (130) adapted to project the image onto an image projection surface (150);
memory (145) for storing first data representing a first display size for the projected image on the image projection surface (150) and second data representing a second display size for the projected image on the image projection surface (150); and
a controller (140) adapted to retrieve one of the first and second data from the memory (145) and, in response thereto, to control the projection lens system (130) to cause the projected image to have a corresponding one of the first and second display sizes on the image projection surface (150).

2. The projection display system (100) of claim 1, further comprising a sensor (160) adapted to detect an ambient light level present in an area where the projection display system (100) is located, and wherein the controller (140) selects one of the first and the second display sizes in response to the detected ambient light level.

3. The projection display system (100) of claim 1, further comprising a user input (170) adapted to receive a size selection indication from a user, and wherein the controller (140) selects one of the first and the second display sizes in response to the size selection indication from the user.

4. The projection display system (100) of claim 1, wherein the controller (140) controls the projection lens system (130) to cause the projected image to have one of the first and the second display sizes on the image projection surface (150) in response to one selected from a group consisting of: a source format of the image; a type of source device providing the image to the projection display system; and a program type for the image.

5. The projection display system (100) of claim 1, wherein a ratio of a diagonal dimension of the first display size to a diagonal dimension of the second display size is at least 3:1.

6. The projection display system (100) of claim 1, where the projection lens system (130) includes a zoom lens adapted to change the size of the projected image in response to the controller (140).

7. The projection display system (100) of claim 1, where the projection lens system (130) includes a means for selectively moving at least one lens into or out of an optical path of the image received from the light modulator (120) in response to the controller (140).

8. A projection display system (100) according to claim 1, wherein the projection lens system (130) includes a scanning laser beam.

9. A projection display system (100) according to claim 1, wherein the first data or second data representing the display size is selected by the controller (140) analyzing electronic data input to be displayed.

10. A method of projecting an image with a projection display system (100), comprising:
generating an image;
selectively retrieving from memory (145) either first data, representing a first display size on an image projection surface (150), or second data, representing a second display size on the image projection surface (150); and
in response to the retrieved data, projecting the image onto the image projection surface (150) at a corresponding one of the first and second display sizes.

11. The method of claim 10, further comprising:
detecting an ambient light level present in an area where the projection display system (100) is located; and
selecting one of the first and the second display sizes in response to the detected ambient light level.

12. The method of claim 10, further comprising:
receiving a size selection indication from a user; and
selecting one of the first and the second display sizes in response to the size selection indication from the user.

13. The method of claim 10, further comprising:
determining one of a source format of the image; a type of source device providing the image to the projection display system; and a program type for the image; and
selecting one of the first and the second display sizes in response to the determined one of the source format, the type of source device, and the program type.

14. The method of claim 10, wherein a ratio of a diagonal dimension of the first display size to a diagonal dimension of the second display size is at least 3:1.

15. The method of claim 10, wherein projecting the image onto the image projection surface (150) at a corresponding one of the first and second display sizes. comprises adjusting a magnification of a zoom lens.

16. The method of claim 10, projecting the image onto the image projection surface (150) at a corresponding one of the first and second display sizes comprises selectively moving at least one lens into or out of an optical path of the projected image.

17. A projection display system (100), comprising:
a light source (110) for producing light;
means (120) for generating an image from the light produced by the light source (110);
projection means (130) for projecting the image onto an image projection surface (150);
means for detecting an ambient light level present in an area where the projection display system (100) is located; and
control means (140) adapted to control the projection means (130) to change a size of a projected image on the image projection surface (150) in response to the detected ambient light level.

18. The projection display system (100) of claim 17, wherein the control means (140) is also adapted to select a size of a projected image in response to size selection input signal from a user, regardless of the detected ambient light level.

19. The projection display system (100) of claim 17 wherein the projection means (130) is adapted to project the image at the first and second display sizes wherein a ratio of a diagonal dimension of the first display size to a diagonal dimension of the second display size is at least 3:1.

20. The projection display system (100) of claim 17, where the projection means (130) includes a zoom lens adapted to change the size of the projected image in response to the control means (140).

21. The projection display system (100) of claim 17, where the projection means (130) includes a means for selectively moving at least one lens into or out of an optical path of the projected image.

22. The projection display system (100) of claim 17, where the means (120) for generating an image includes one of a liquid crystal device or a digital micromirror device (DMD).
